(19) United States
(12) Patent Application Publication
(10) Pub. No.: US 2023/0056401 A1
(43) Pub. Date: Feb. 23, 2023

(54) DEMAND SHOCK DETECTION FOR DYNAMIC DEMAND FORECASTING

(71) Applicant: Amadeus S.A.S., Biot (FR)

(72) Inventors: Michael Wittman, Copenhagen (DK); Thomas Fiig, Rungsted Kyst (DK); Giovanni Gatti Pinheiro, Le Rouret (FR); Michael Defoin Platel, Les Adrets de l'Esterel (FR); Riccardo Jadanza, Biot (FR)

(21) Appl. No.: 17/518,802

(22) Filed: Nov. 4, 2021

Related U.S. Application Data
(60) Provisional application No. 63/235,444, filed on Aug. 20, 2021.

(51) Int. Cl. G06Q 30/02; G06N 20/00

(52) U.S. Cl. CPC G06Q 30/0202; G06Q 30/0201; G06N 20/00

(57) ABSTRACT

Systems and methods for implementing a machine learning framework for demand shock detection for dynamic demand forecasting. A method includes generating predicted booking observations with a demand model trained using a training set of historical booking data. Transient booking observations are obtained from an active database. An observed likelihood score is computed from the transient booking observations based on the demand model trained on the historical booking data. A demand shock threshold is computed based on the statistical relationship between a time to detection of the demand shock event and at least one shock detection criterion. An occurrence of a demand shock event is determined by comparing the observed likelihood score to the demand shock threshold.

### TECHNICAL FIELD

The present invention relates generally to machine learning techniques, although not limited thereto. More specifically, the present invention relates to techniques of implementing a machine learning framework for demand shock detection for dynamic demand forecasting.

### BACKGROUND

Revenue management systems implement various demand forecasting methodologies that estimate or predict future resource demand using historical data. For example, time series analysis or machine learning techniques may be implemented to develop models that forecast future demand based on historical data. Existing systems may implement a passive framework in which demand parameters are periodically estimated and it is assumed that an estimated demand function remains static between re-estimations of demand parameters. However, that assumption is less than accurate in view of constantly varying demand behavior. Such assumptions render existing systems particularly sensitive to demand shock events that substantially modify demand behavior in a relatively short time. Demand shock events resulting in unobservable, sudden changes in customer behavior are a common source of forecast error in revenue management systems. The COVID-19 pandemic is one example of a highly impactful macro-level demand shock event that significantly affected demand patterns in the airline industry and required manual intervention from airline analysts. Smaller, micro-level demand shock events also frequently occur due to special events or changes in competition. Demand shock detection methods employed by airlines today are often quite rudimentary in practice and difficult for airline analysts to configure. Thus, improved demand forecasting techniques are needed to remediate demand shock effects.

### SUMMARY

Embodiments of the present invention provide systems, methods, and computer-readable storage media for providing implementing a machine learning framework for demand shock detection for dynamic demand forecasting. In an embodiment, a method includes generating predicted booking observations with a demand model trained using a training set of historical booking data. Transient booking observations are obtained from an active database. An observed likelihood score is computed from the transient booking observations based on the demand model trained on the historical booking data. A demand shock threshold is computed based on a statistical relationship between a time to detection of a demand shock event and at least one shock detection criterion. An occurrence of a demand shock event is determined by comparing the observed likelihood score to the demand shock threshold. If a demand shock even is detected, an alert is raised to a user.

These and other embodiments can each optionally include one or more of the following features.

In some embodiments of the invention, the demand shock threshold is computed based on detecting a demand shock of a given magnitude at a given statistical accuracy within a desired detection time.

In some embodiments of the invention, the demand shock threshold is computed based on a distribution of likelihood scores from simulated instances of transient booking observations that is generated based on an assumption that no demand shock has occurred.

In some embodiments of the invention, the method further includes determining a statistical relationship between an offered price and bookings associated with the historical and transient booking observations.

In some embodiments of the invention, the at least one shock detection criterion is based on a desired magnitude of the detected shock event. In some embodiments of the invention, the at least one shock detection criterion is based on a desired statistical power. In some embodiments of the invention, the at least one shock detection criterion is based on a sample size of the transient booking observations.

In some embodiments of the invention, generating the predicted booking observations includes computing a probability that a travel service or a flight will receive a given number of bookings by a given day-to-departure (“DTD”) based on a demand forecast obtained using the demand model.

In some embodiments of the invention, the method further includes generating a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model.

In some embodiments of the invention, a system includes one or more processors, at least one memory device coupled with the one or more processors, and a data communications interface operably associated with the one or more processors, where the at least one memory device contains a plurality of program instructions that, when executed by the one or more processors, cause the system to perform steps. In an embodiment, the steps include generating predicted booking observations with a demand model trained using a training set of historical booking data. Transient booking observations are obtained from an active database. An observed likelihood score is computed from the transient booking observations based on the demand model trained on the historical booking data. A demand shock threshold is computed based on a statistical relationship between a time to detection of a demand shock event and at least one shock detection criterion. An occurrence of a demand shock event is determined by comparing the observed likelihood score to the demand shock threshold.

In some embodiments of the invention, a computer program product includes a non-transitory computer-readable storage medium, and program code stored on the non-transitory computer-readable storage medium that, when executed by one or more processors, causes the one or more processors to perform steps. In an embodiment, the steps include generating predicted booking observations with a demand model trained using a training set of historical booking data. Transient booking observations are obtained from an active database. An observed likelihood score is computed from the transient booking observations based on the demand model trained on the historical booking data. A demand shock threshold is computed based on a statistical relationship between a time to detection of a demand shock event and at least one shock detection criterion. An occurrence of a demand shock event is determined by comparing the observed likelihood score to the demand shock threshold.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, serve to explain the embodiments of the invention. In the drawings, like reference numerals are used to indicate like parts in the various views.

FIG. 1 is a block diagram of an example operating environment that is suitable for implementing aspects of the present invention.

FIG. 2 is a block diagram of an example reservation system that is suitable for implementing aspects of the present invention.

FIG. 3 is a block diagram of an example revenue management system, in accordance with an embodiment of the present invention.

FIG. 4 is a graphical view that illustrates a conceptual, high-level overview of using booking data in demand forecasting and resource optimization, in accordance with an embodiment of the present invention.

FIG. 5 is a graphical view that illustrates an example of how a demand shock can affect transient booking observations, in accordance with an embodiment of the present invention.

FIG. 6 is a block diagram that illustrates forecast model sampling and generating probability distributions of observing likelihood scores from a set of booking trajectories for an assumption of both with and without a demand shock, in accordance with an embodiment of the present invention.

FIG. 7 are graphical views that illustrate the performance of the demand shock detector in four environments with different demand shocks, in accordance with an embodiment of the present invention.

FIG. 8 is a graphical view that illustrates a relationship between the number of booking trajectories contained in the trajectory set and the alarm time of the shock detector, in accordance with an embodiment of the invention.

FIGS. 9A, 9B are graphical views that illustrate the relationship between demand shock intensity and an alarm time of the shock detector, in accordance with an embodiment of the invention.

FIG. 10 is a flow-chart illustrating an example of a method of implementing a framework for iteratively training a demand model, in accordance with an embodiment of the invention.

FIG. 11 is a block diagram of an example computing environment suitable for use in implementing embodiments of the invention.

### DETAILED DESCRIPTION

Techniques described herein relate to implementing a framework for iteratively training a demand (or forecast) model. Demand forecasting generally involves predicting future resource demand using historical data. To that end, machine learning and/or predictive analytic methodologies (e.g., regression algorithms) are used to train models that estimate relationships between demand and one or more features identified within the historical data. Implementing trained models enable a computing device (e.g., a revenue management system) to execute automated, data driven decisions concerning managed resources as the computing device receives new observations. Such demand forecasting techniques may be implemented in various contexts, including energy utilities, on-demand cloud computing platforms, travel reservation systems, and the like.

Revenue management systems implement various demand forecasting methodologies that estimate or predict future resource demand using historical data. For example, time series analysis or machine learning techniques may be implemented to develop models that forecast future demand based on historical data. Existing systems may implement a passive framework in which demand parameters are periodically estimated and it is assumed that an estimated demand function remains static between re-estimations of demand parameters. However, that assumption is less than accurate in view of constantly varying demand behavior.

Such assumptions render existing systems particularly sensitive to demand shock events that substantially modify demand behavior in a relatively short time. For example, demand shock events may include the entry and exit of competitors, changes in the competitor marketplace, price changes, changes of customer behavior, macro-economic changes, a pandemic, new products, special events of which the forecast system is unaware, and the like. Demand shock events can vary in intensity and scope, affecting one or more flights or markets.

For example, in the travel industry, such as airlines, revenue management analysts monitor flights and manage the steering of available price points by adjusting the demand forecast to represent better future expectations. Since demand shock events result in unobservable, sudden changes in customer behavior, they are a common source of forecast error in revenue management systems that must be detected and corrected by airline analysts. Demand shock detection methods employed by airlines today are often quite rudimentary in practice and difficult for airline analysts to configure. Thus, improved demand forecasting techniques are needed to remediate demand shock effects.

The technology in this patent application is related to systems and methods for implementing an improved statistical test using continuously updated live data to validate whether demand behavior is varying from forecast expectations, signaling that a demand shock has occurred. Based on simulation studies, the time that elapsed to detect a change in the demand behavior dramatically decreases when combining data from different subsets of data (e.g., flights). This combination of data can provide a change detection mechanism at the market level (e.g., flights are misbehaving as a group). In other words, processes described herein for demand shock detection can provide a hierarchical view of misbehavior, either at a component level (e.g., flight level), at market levels, or any other aggregation level that is needed.

More specifically, this technology includes a process that generates predicted booking observations with a demand model trained using a training set of historical booking data, obtains transient booking observations, computes an observed likelihood score, computes a demand shock threshold based on the statistical relationship between a time to detection of a demand shock event and at least one shock detection criterion, and determines an occurrence of a demand shock event by comparing the observed likelihood score to the demand shock threshold. The shock detection criterion can include, but are not limited to, shock intensity, sample size, false negative rate, false positive rate, and the like. The shock detection threshold can either be computed analytically based on statistical relationships, or alternatively, determined via a simulation that generates a distribution of scores assuming no shock behavior has occurred.

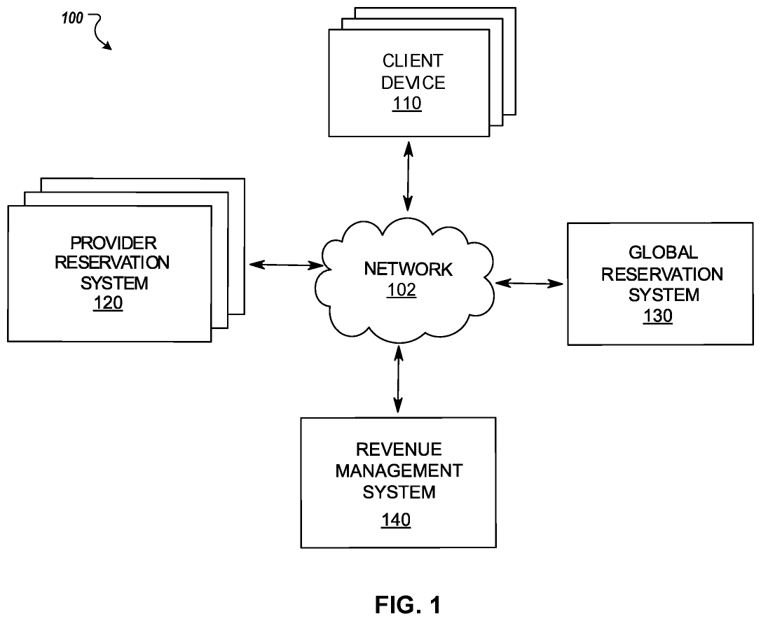

FIG. 1 illustrates an example operating environment for implementing aspects of the present invention is illustrated and designated generally 100. In general, operating environment 100 represents the various systems involved in processing travel reservations for users (e.g., customers or passengers) in the travel industry. Operating environment 100 includes client device 110, provider reservation system (PRS) 120, global reservation system (GRS) 130, and revenue management system (RMS) 140. As depicted in FIG. 1, the various systems communicate with each other via network 102, which may include one or more public and/or private networks. Examples of networks that are suitable for implementing network 102 include: local area networks (LANs), wide area networks (WANs), cellular network, the Internet, and the like.

In operation, client device 110 interacts with PRS 120 and/or GRS 130 to obtain data related to travel services (“travel-related data”) and services related to booking travel services (“travel-related services”). Examples of travel-related data include inventory data, fare data, routing data, scheduling data, and the like. Examples of travel-related services include reserving travel services that define an itinerary, ticketing the reserved travel services that define an itinerary, and the like. For the purposes of the present disclosure, an “itinerary” refers to a structured travel route between an origin location and a destination location. Examples of systems suitable for implementing client device 110 include: a smartphone, a laptop, a personal computer, a mobile computing device, a cryptic terminal, a remote server hosting a travel metasearch website, and the like.

PRS 120 is a computer reservation system configured to provide customers with both travel-related data and travel-related services associated with a particular travel provider.

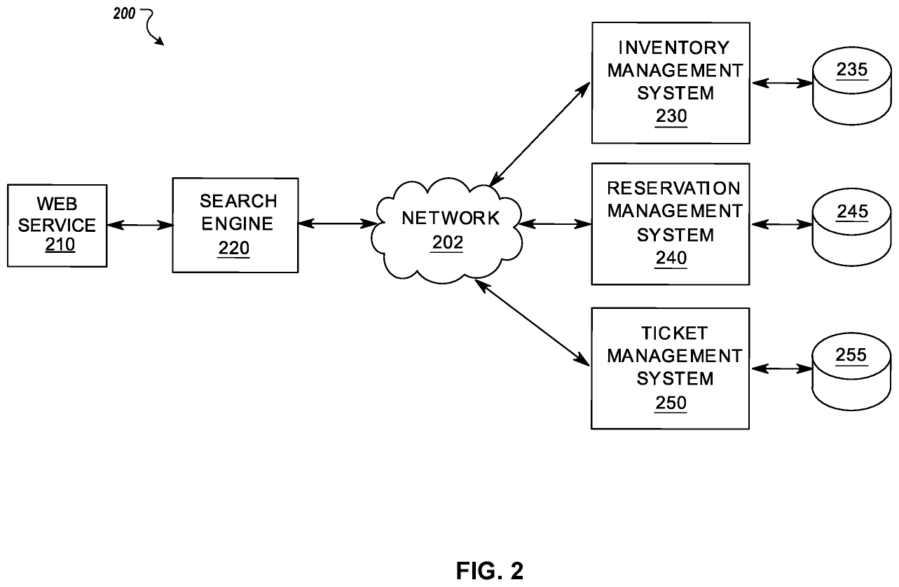

GRS 130 is another computer reservation system configured to provide customers with both travel-related data and travel-related services. In contrast to PRS 120, the travel-related data and travel-related services that GRS 130 provides is associated with multiple travel providers. In an embodiment, a reservation system described below with respect to FIG. 2 may be used to implement PRS 120, GRS 130, or a combination thereof.

In an embodiment, GRS 130 directly accesses travel-related data associated with a particular travel provider using a web service interface published by a remote server hosting that travel-related data. For example, an inventory management system of PRS 120 may publish a web service interface for accessing travel-related data associated with a particular travel provider. In an embodiment, a remote server periodically pushes travel-related data associated with a particular travel provider to GRS 130 where that travel-related data is locally replicated. For example, an inventory management system of PRS 120 may periodically push travel-related data associated with a particular travel provider to GRS 130 for local replication. In an embodiment, GRS 130 stores and manages travel-related data for PRS 120.

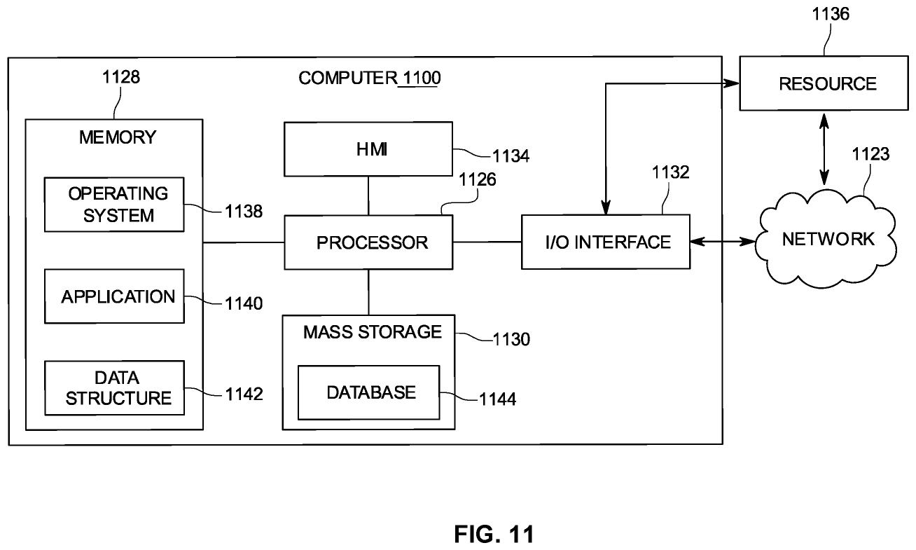

Each of the systems shown in FIG. 1 may be implemented via any type of computing system, such as computing system 1100 described in greater detail below with respect to FIG. 11, for example. Each system shown in FIG. 1 may include a single device or multiple devices cooperating in a distributed environment. For instance, GRS 130 may be provided via multiple devices arranged in a distributed environment that collectively provide the functionality described herein. Additionally, other components not shown may also be included within the distributed environment.

FIG. 2 is a block diagram depicting an example reservation environment 200 that is suitable for implementing aspects of the present invention. In an embodiment, reservation environment 200 is implemented by PRS 120 of FIG. 1. Alternatively, in an embodiment, reservation environment 200 is implemented by GRS 130. As depicted in FIG. 2, reservation environment 200 includes front-end systems and back-end systems that exchange data via a network 202 composed of public and private networks, such as the Internet and a reservation system intranet. Front-end systems, such as search engine 220, interact directly with clients (e.g., client device 110 of FIG. 1) of reservation environment 200 during a travel reservation process. In contrast, clients of reservation environment 200 are not exposed to back-end systems that store the travel-related data and effectuate the travel-related services in reservation environment 200, such as inventory management system 230, reservation management system 240, and ticket management system 250.

Web service 210 is configured to facilitate networked communications between front-end systems of reservation environment 200, such as search engine 220, and applications executing on a remote client device (e.g., client device 110 of FIG. 1). For example, during a search phase of a travel reservation process, search queries submitted by clients of reservation environment 200 are directed to search engine 220 via web service 210. Search engine 220 is configured to identify search results having at least one itinerary that satisfies search parameters included in each search query. Examples of such search parameters may include: an origin location, a destination location, a departure date, a return date, a number of passengers associated with a travel request (“a number in party”), a booking class, a number of stops, a flight number, a travel provider identifier, a cabin class (e.g., First Class or Economy), and the like. Search engine 220 is further configured to communicate identified search results to the client devices via web service 210.

Inventory-related data for one or more travel providers is stored in inventory database 235 under the control of inventory management system 230. In an embodiment, inventory-related data includes availability information that defines unreserved travel services inventory. As used herein, “unreserved travel services inventory” relates to portions of a travel services inventory that are not associated with any reservation records stored in reservation database 245. In contrast, “reserved travel services inventory” relates to portions of a travel services inventory that are associated with one or more reservation records stored in reservation database 245. In an embodiment, inventory-related data includes fare information associated with the unreserved travel services inventory.

Reservation records for one or more travel providers are stored in reservation database 245 under the control of reservation management system 240. Reservation management system 240 is configured to interact with search engine 220 to process reservation requests received during a booking phase of a travel reservation process. In response to receiving a reservation request identifying a travel itinerary, reservation management system 240 generates a reservation record in reservation database 245. In an embodiment, the reservation record is a passenger name record (“PNR”). The reservation record includes booking data and a record locator that uniquely identifies the reservation record in reservation database 245. The record locator may also be referred to as a confirmation number, reservation number, confirmation code, booking reference, and the like.

Booking data generally includes travel information defining various travel services included in an itinerary, pricing/payment information, and passenger information related to one or more passengers associated with the reservation record. Examples of travel information include: an origin location, a destination location, a departure date, a return date, a booking date, a number in party, a booking class, a number of stops, a flight number, a travel provider identifier, a cabin class, and the like. Examples of passenger information, for each passenger among the one or more passengers associated with a reservation record, include: name, gender, date of birth, citizenship, home address, work address, passport information, and the like.

Ticket records for one or more travel providers are stored in ticketing database 255 under the control of ticket management system 250. Ticket management system 250 is configured to interact with search engine 220, inventory management system 230, and reservation management system 240 to process ticket issuance requests received during a ticketing phase of a travel reservation process. In processing ticket issuance requests, ticket management system 250 generates ticket records in ticketing database 255 for each travel service segment (“segment”) and each passenger associated with the reserved travel itinerary using travel information and passenger information in the reservation record.

For example, a reservation record may include passenger information related to two passengers. The reservation record may further include travel information defining two flight segments for travel from an origin location to a destination location via a stopover location and one flight segment for travel from the destination location to the origin location. In this example, the travel information defines three total flight segments for two passengers. In response to receiving a ticket issuance request associated the reservation record in this example, ticket management system 250 would generate six ticket records in ticketing database 255. Ticket management system 250 would submit a request to reservation management system 240 to update the reservation record stored in reservation database 245 to include six ticket numbers that identify each ticket record generated. That is, in this example, a single reservation record stored in reservation database 245 would include ticket numbers identifying six ticket records stored in ticketing database 255.

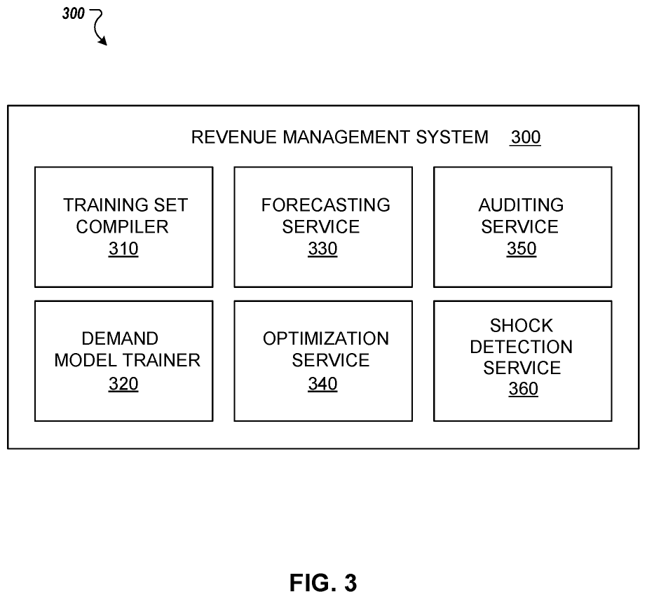

FIG. 3 is a block diagram of an example revenue management system (“RMS”) 300 (e.g., RMS 140 of FIG. 1) that is suitable for implementing aspects of the present invention. RMS 300 is generally configured to optimize one or more objective metrics by executing automated, data-driven decisions concerning travel services inventory using machine learning and/or predictive analytic methodologies to iteratively train demand models. To that end, RMS 300 includes: training set compiler 310, demand model trainer 320, forecasting service 330, optimization service 340, auditing service 350, and shock detection service 360. In an embodiment, RMS 300 is hosted by computing resources provided by reservation environment 200 of FIG. 2.

Training set compiler 310 is configured to populate, compile, or build training sets of booking data by interacting with reservation management system 240. Demand model trainer 320 is configured to train one or more demand models using training sets obtained from training set compiler 310. In an embodiment, demand model trainer 320 is implemented using a machine learning algorithm. Forecasting service 330 is configured to generate predicted booking observations for active travel services using demand models trained by demand model trainer 320.

Optimization service 340 is configured to select one or more inventory control attributes that maximize one or more objective metrics of reservation environment 200 using predicted booking observations generated by forecasting service 330. Optimization service 340 is further configured to interact with inventory management system 230 to include the selected one or more inventory control attributes.

Auditing service 350 is configured to detect variances between predicted booking observations generated by forecasting service 330 and transient booking observations stored in reservation database 245 corresponding to active travel services departing on a future date (“active travel services”). Auditing service 350 is further configured to activate shock detection service 360 to improve statistical testing using continuously updated live data to validate whether demand behavior is varying from forecast expectations, signaling that a demand shock has occurred. In an embodiment, auditing service 350 includes a demand shock detection process. In an embodiment, an auditing service 350 generates a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model trainer 320.

Shock detection service 360 is configured to determine an occurrence of a demand shock event during a particular time period by comparing an observed likelihood score to a computed demand shock threshold. To that end, shock detection service 360 includes a process that generates predicted booking observations with a demand model trained using a training set of historical booking data, obtains transient booking observations, computes an observed likelihood score, computes a demand shock threshold based on the statistical relationship between a time to detection of a demand shock event and at least one shock detection criterion, and determines an occurrence of a demand shock event by comparing the observed likelihood score to the demand shock threshold. The shock detection criterion can include, but are not limited to, shock intensity, sample size, false negative rate, false positive rate, and the like. The shock detection threshold can be computed analytically by the shock detection service 360 based on statistical relationships. Additionally, or alternatively, in an embodiment, the shock detection threshold can be determined by the shock detection service 360 via a simulation that generates a distribution of scores assuming no shock behavior has occurred.

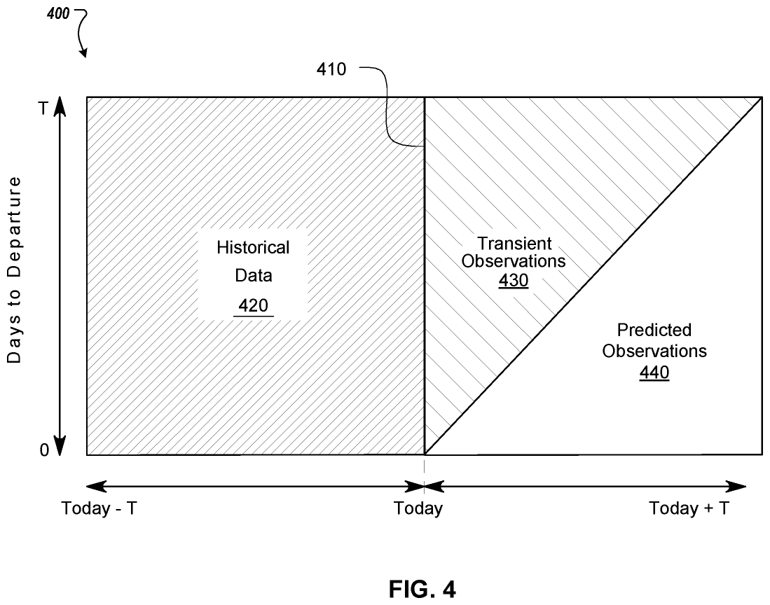

FIG. 4 is a graphical view 400 that illustrates a conceptual, high-level overview of using booking data in demand forecasting and resource optimization, in accordance with an embodiment of the present invention. As discussed above, demand forecasting techniques involving models trained by machine learning and/or predictive analytic methodologies may be implemented in various contexts, including travel reservation systems like reservation environment 200. Booking data stored in reservation database 245 facilitates various aspects of demand forecasting and resource optimization for reservation environment 200. As illustrated in FIG. 4, a line 410 associated with a current departure date partitions historical or archived booking data 420 corresponding to previously departed travel services (“inactive travel services”) from transient booking observations 430 corresponding to travel services departing on future dates (“active travel services”) and predicted booking observations 440 corresponding to forecasting data for active travel services (e.g., generated by forecasting service 330).

A demand model trainer (e.g., demand model trainer 320 of FIG. 3) can apply machine learning and/or predictive analytic methodologies (e.g., regression algorithms) to historical booking data 420 to train demand models. Demand models trained using historical booking data may then be used to select one or more inventory control attributes for active travel services associated with transient booking observations 430 that maximize one or more objective metrics of the revenue management system 300. Such inventory control attribute may include attributes configured to: adjust availabilities among multiple fare classes for specific active travel services, cancel an active travel service to reduce supply, and the like. Examples of objective metrics include: utilization rate per segment, utilization rate per flight, revenue per segment, revenue per flight, revenue per passenger-mile, and the like.

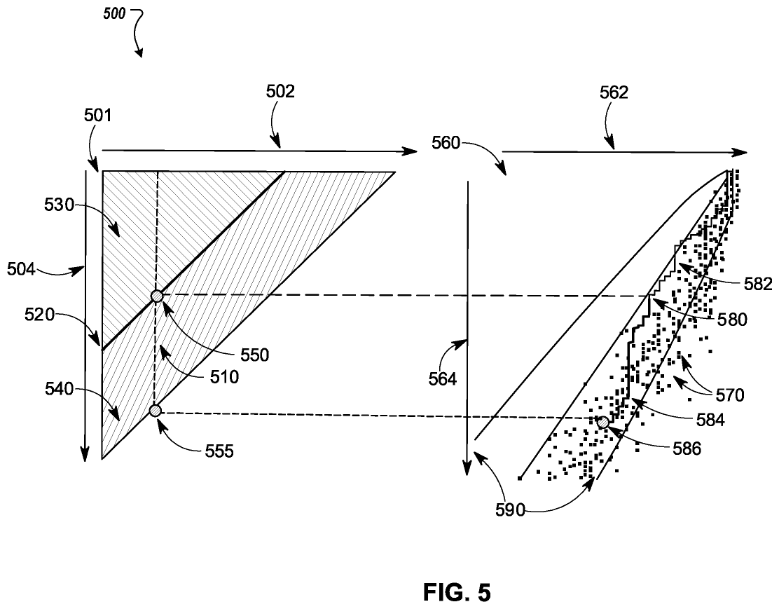

FIG. 5 is a graphical view 500 that illustrates an example of how a demand shock can affect transient booking observations, in accordance with an embodiment of the present invention. In particular, FIG. 5 illustrates a conceptual example of how a demand shock can affect transient booking observations. Triangle 501 represents an instance of transient booking observations, similar to transient booking observations 430 in FIG. 4. Horizontal axis 502 represents the departure date for an active travel service, and vertical axis 504 represents the remaining days to departure. Transient booking observations (triangle 501) consists of one or more booking trajectories 510, each representing an active travel service. A booking trajectory consists of data containing the prices offered and bookings made for the active travel service for each day up to and including the current day to departure.

In an embodiment illustrated by graphical view 500, a demand shock has caused customer behavior to abruptly change for the active travel services. Diagonal line 520 indicates when the demand shock occurred. The intersection 550 between diagonal line 520 and a booking trajectory 510 indicates when the demand shock affected that particular booking trajectory. As such, region 530 represents the portion of the transient booking observations collected prior to the demand shock, and region 540 represents the portion of the transient booking observations collected after the demand shock.

The right panel of the illustration 560 plots the state space consisting of the remaining capacity and remaining days to departure for the transient booking observations (triangle 501). Horizontal axis 562 represents the remaining capacity for each active travel service, and vertical axis 564 represents the remaining days to departure. The most recent position of each booking trajectory in transient booking observations (triangle 501) are plotted with examples of such trajectory positions 570. The path of example trajectory 510 through state space is shown as trajectory line 580. The top-most portion of the line 582 is collected prior to the demand shock, and the bottom-most portion of the line 584 is collected after the demand shock. The current trajectory position of booking trajectory 510 is shown as dot 586.

Using the demand model, a confidence cone 590 can be constructed in capacity-time state space. The confidence cone can be used to identify the trajectory positions that are likely to have occurred given the estimated demand forecast model. Trajectory positions that lie outside the confidence cone, for example trajectory positions 570, would be unlikely to occur if there was no demand shock. However, even though example trajectory line 580 was affected by a demand shock, its final trajectory position at dot 586 is still within the confidence cone 590. This indicates that the demand shock detection service 360 must consider the likelihood of observing each booking trajectory in state space to determine whether or not a demand shock has occurred.

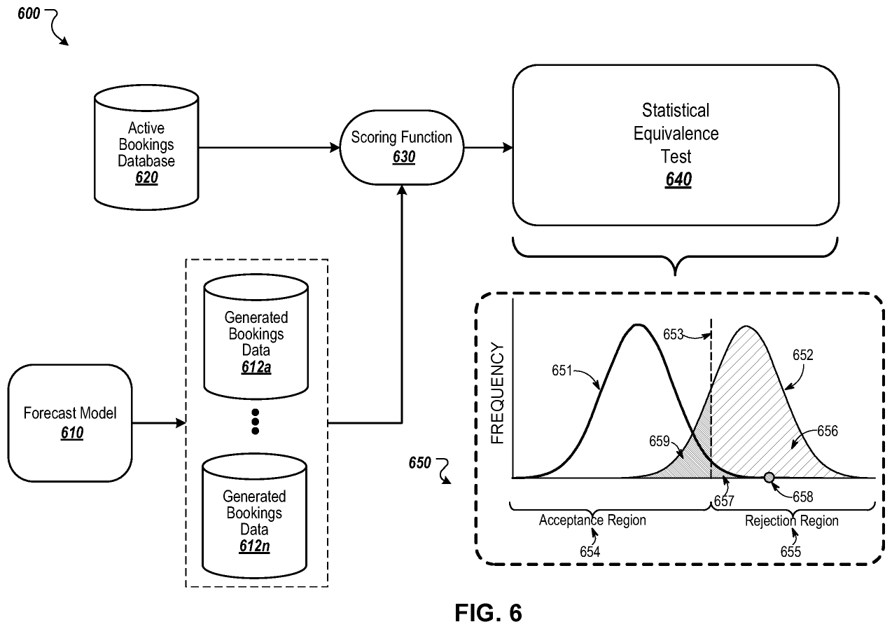

FIG. 6 is a block diagram 600 that illustrates forecast model sampling and generation of probability distributions of observing likelihood scores from a set of booking trajectories for an assumption of both with and without a demand shock, in accordance with an embodiment of the present invention. In particular, a forecast model 610 is used to create multiple instances of generated booking data 612a-n (e.g., predicted bookings observations 440 of FIG. 4). The multiple instances of generated booking data 612a-n may vary based on the stochasticity of demand assumed by the forecast model 610. The shock detection algorithm (e.g., via shock detection service 360) computes a likelihood score of observing each of the multiple instances of generated booking data via a scoring function 630. Similarly, the shock detection algorithm (e.g., via shock detection service 360) computes a likelihood score of observing scores the active bookings database 620 (e.g., transient bookings data 430 of FIG. 4) via a scoring function 630. The scoring function 630 is used by statistical equivalence test 640 to determine whether there is an occurrence of a demand shock event by comparing the scores to a demand shock threshold, as illustrated in graph 650.

In particular, graph 650 illustrates the probability distribution 651 of observing a particular likelihood score from a set of booking trajectories (trajectory set), assuming that no demand shock has occurred. In an embodiment, probability distribution 651 is computed by aggregating the computed likelihood scores of each of the multiple instances of generated booking data 612a-n. Probability distribution 652 shows the likelihood of observing a particular likelihood score from a set of booking trajectories, assuming that a demand shock has occurred at a specific time and at a specific intensity. In an embodiment, as illustrated in graph 650, the post-shock distribution 652 has shifted to the right as compared to the pre-shock distribution 651. In an embodiment, distributions 651 and 652 can be computed analytically or via simulation.

Line 653 shows the computed likelihood score threshold that defines the acceptance region 654 and the rejection region 655 of a statistical hypothesis test. In an embodiment, a demand shock threshold (line 653) can be computed to result in a desired statistical power (true positive rate) represented by area 656, a desired significance for an incorrect shock alert (false positive) represented by area 657, and an incorrect classification for no shock (false negative) represented by area 659. In an embodiment, demand shock threshold (line 653) can be computed to result in a desired time to shock detection. In an embodiment, demand shock threshold (line 653) can be computed to detect shocks of a desired shock magnitude. In an embodiment, demand shock threshold (line 653) can be computed to detect shocks affecting a given number of booking trajectories.

In an embodiment, a computed likelihood score for an observed set of booking trajectories 658 (for example, from active bookings database 620) is compared to the computed demand shock threshold (line 653). If the observed likelihood score is within the acceptance region 654, the shock detector does not indicate a demand shock has occurred for the observed set of booking trajectories. If the observed likelihood score is within the rejection region 655, the shock detector indicates that a demand shock has occurred for the observed set of booking trajectories. For example, computed likelihood score for an observed set of booking trajectories 658 is located in rejection region 655, indicating that a demand shock would be flagged for that trajectory set.

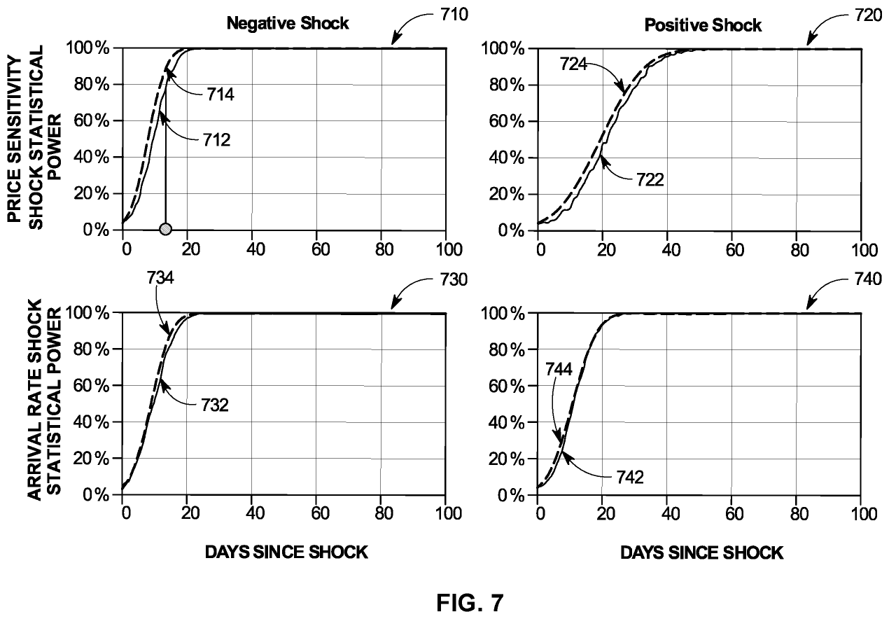

FIG. 7 is a view of graphs 710, 720, 730, and 740 that illustrate the performance of the demand shock detector in four environments with different demand shocks, in accordance with an embodiment of the present invention. Graphs 710 and 720 represent negative and positive demand shocks in a willingness-to-pay parameter, respectively. Graphs 730 and 740 represent negative and positive demand shocks in demand volume, respectively. The vertical axis in each graph represents the statistical power (true positive rate) of the shock detector, and the horizontal axis of the graph represents the number of days since the demand shock occurred. Lines 712, 722, 732, and 742 represent the performance of the shock detector in a simulated environment where the shock detection threshold (e.g., line 653 in FIG. 6) is computed from a probability distribution of generated booking data (e.g., the multiple instances of generated booking data 612a-n in FIG. 6). Lines 714, 724, 734, and 744 represent the estimated performance of the detector where the shock detection threshold is computed based on the statistical relationship between a time to detection of a demand shock event and at least one known shock detection criterion. In an embodiment, as illustrated in all graphs 710, 720, 730, and 740, both methods of computing the shock detection threshold produce very similar results. Additionally, in an embodiment, as illustrated in all graphs 710, 720, 730, and 740, the statistical power of the shock detector increases as more time passes since the shock.

The alarm time of the shock detector can be computed as the number of days after the demand shock that the statistical power of the detector reaches a desired level. For example, in graph 710, the alarm time when the statistical power of the detector reaches 80% is marked 716. In an embodiment, as illustrated in graph 710, the alarm time increases with the desired statistical power. Comparing graphs 720 and 740 with graphs 710 and 730, the shock detector detects negative shocks in a willingness-to-pay parameter or an arrival rate parameter more quickly than an equivalent negative shock in the same parameter.

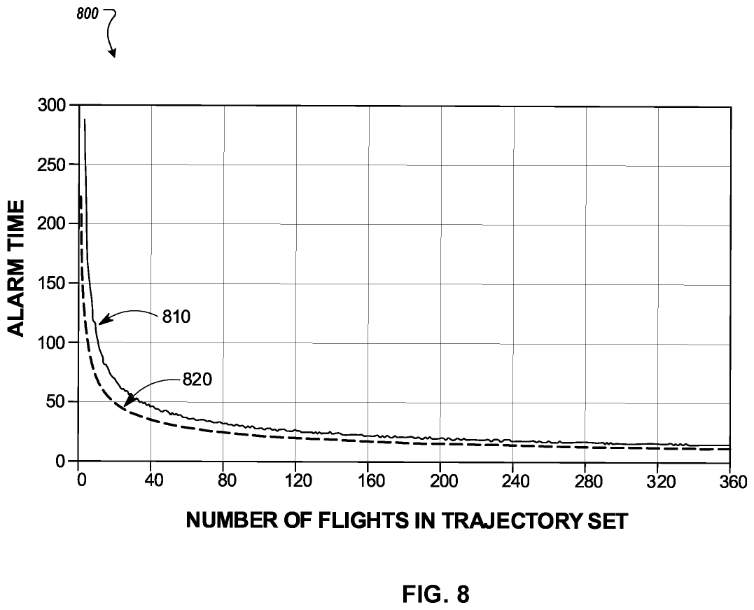

FIG. 8 is a view of graph 800 that illustrates a relationship between the number of booking trajectories contained in the trajectory set and the alarm time of the shock detector, in accordance with an embodiment of the invention. In particular, graph 800 illustrates the relationship between the number of booking trajectories contained in the trajectory set and the alarm time of the shock detector. The horizontal axis represents the number of booking trajectories contained in the trajectory set, and the vertical axis represents the alarm time, measured as the number of days after the shock at which the statistical power reaches 80%. Line 810 shows the performance of the shock detector in a simulated environment where the shock detection threshold (e.g., line 653 in FIG. 6) is computed from a probability distribution of generated booking data. Line 820 shows the estimated performance of the detector where the shock detection threshold is computed based on the statistical relationship between a time to detection of a demand shock event and at least one known shock detection criterion. In an embodiment, as illustrated in graph 800, the alarm time decreases as the number of flights in the trajectory set increases.

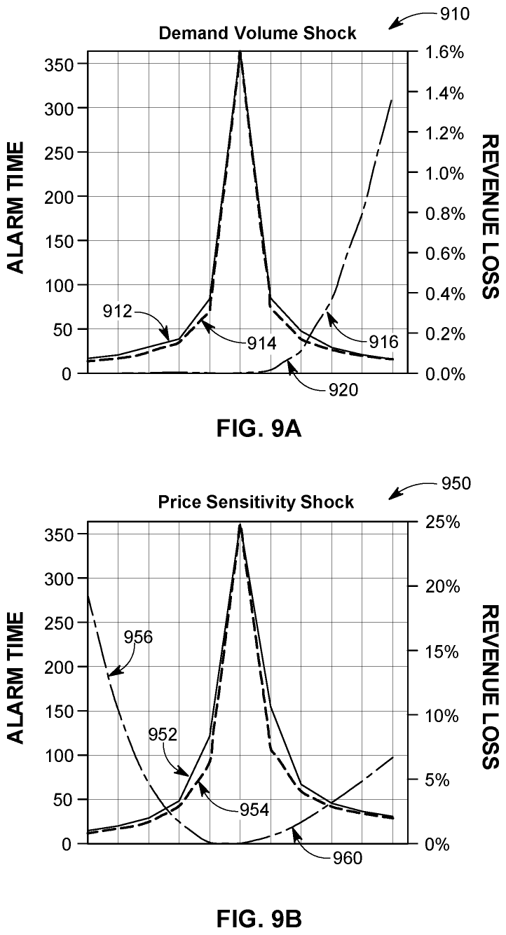

FIG. 9A is a view of graph 910 that illustrates the relationship between demand volume shock and an alarm time of the shock detector, and FIG. 9B is a view of graph 950 that illustrates the relationship between price sensitivity shock and an alarm time of the shock detector, in accordance with an embodiment of the invention. In graphs 910 and 950, the horizontal axis measures the shock intensity in a willingness to pay parameter or an arrival rate parameter, respectively, where the centers of the axes 920 and 960 represents an environment in which no demand shock has occurred. The left vertical axis represents the alarm time, measured as the number of days after the shock at which the statistical power reaches 80%. The right vertical axis shows the estimated revenue loss resulting from not updating the demand model to account for the demand shock. Lines 912 and 952 show the performance of the shock detector in a simulated environment where the shock detection threshold (e.g., line 653 in FIG. 6) is computed from a probability distribution of generated booking data. Lines 914 and 954 show the estimated performance of the detector where the shock detection threshold is computed based on the statistical relationship between a time to detection of a demand shock event and at least one known shock detection criterion. Lines 916 and 956 show the estimated revenue loss from not adapting the forecast model to the post-shock demand behavior.

In an embodiment, as illustrated by graphs 910 and 950, the alarm time of the shock detector decreases as the demand shocks become more intense (moving away from the center of the axis 920 and 960). In an embodiment, as illustrated by graphs 910 and 950, the revenue loss increases as the demand shocks become more intense. In an embodiment, the combination of these two effects suggests that the demand shock detector can more quickly detect demand shocks that are more costly to revenues.

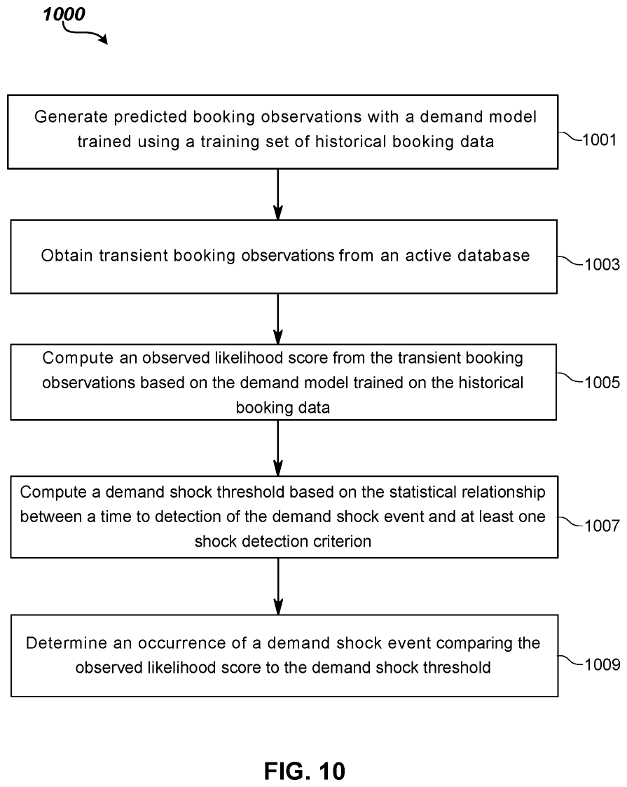

FIG. 10 is a flowchart illustrating an example method 1000 of implementing a machine learning framework for detecting a demand shock, in accordance with an embodiment of the invention. In an embodiment, method 1000 is implemented by revenue management system 300 of FIG. 3.

At step 1001, generating predicted booking observations with a demand model trained using a training set of historical booking data. For example, as illustrated in FIG. 4, predicted booking observations 440 corresponding to forecasting data for active travel services (e.g., generated by forecasting service 330).

In an embodiment, generating the predicted booking observations includes computing a probability that a travel service or flight will receive a given number of bookings by a given day-to-departure (“DTD”) based on a demand forecast obtained using the demand model.

At step 1003, obtaining transient booking observations from an active database. For example, as illustrated in FIG. 4, transient booking observations 430 corresponding to travel services departing on future dates (“active travel services”).

At step 1005, computing an observed likelihood score from the transient booking observations based on the demand model trained on the historical booking data. For example, in an embodiment, auditing service 350 can generate a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model trainer 320.

At step 1007, computing a demand shock threshold based on the statistical relationship between a time to detection of the demand shock event and at least one shock detection criterion. In an embodiment, the demand shock threshold is computed based on a distribution of likelihood scores from simulated instances of transient booking observations. For example, in an embodiment, the shock detection service 360 may be configured to determine an occurrence of a demand shock event during a particular time period by comparing an observed likelihood score to a computed demand shock threshold. For example, graph 650 illustrates the probability distribution 651 of observing a particular likelihood score from a set of booking trajectories (trajectory set), assuming that no demand shock has occurred. Probability distribution 652 shows the likelihood of observing a particular likelihood score from a set of booking trajectories, assuming that a demand shock has occurred at a specific time and a specific intensity. In an embodiment, as illustrated in graph 650, the post-shock distribution 652 has shifted to the right as compared to the pre-shock distribution 651. In an embodiment, distributions 651 and 652 can be computed analytically or via simulation.

In an embodiment, the demand shock threshold is computed based on detecting a demand shock of a given magnitude at a given statistical accuracy within a desired detection time. In an embodiment, the demand shock threshold is computed based on a distribution of likelihood scores from simulated instances of transient booking observations that is generated based on an assumption that no demand shock has occurred. For example, the shock detection threshold (e.g., line 653 of FIG. 6) can be computed analytically based on the statistical relationships described herein (e.g., computed from a probability distribution of generated booking data such as the multiple instances of generated booking data 612a-n in FIG. 6). Alternatively, the shock detection threshold (e.g., line 653 of FIG. 6) may be determined via a simulation that compares a score computed for a cluster of flights to a distribution of scores that is generated assuming no shock behavior has occurred.

In an embodiment, the at least one shock detection criterion is based on a desired magnitude of the detected shock event. In an embodiment, the at least one shock detection criterion is based on a desired statistical power. In an embodiment, the at least one shock detection criterion is based on a sample size of the transient booking observations.

At step 1009, determining an occurrence of a demand shock event by comparing the observed likelihood score to the demand shock threshold. For example, shock detection service 360 includes a process that generates predicted booking observations with a demand model trained using a training set of historical booking data, obtains transient booking observations, computes an observed likelihood score, computes a demand shock threshold based on the statistical relationship between a time to detection of a demand shock event and at least one shock detection criterion, and determines an occurrence of a demand shock event by comparing the observed likelihood score to the demand shock threshold.

In an embodiment, method 1000 further includes determining a statistical relationship between an offered price and bookings associated with the historical and transient booking observations.

In an embodiment, method 1000 further includes generating a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model.

In an embodiment, method 1000 is performed by processing logic, including hardware, firmware, software, or a combination thereof. In an embodiment, method 700 is performed by a processor executing code stored in a non-transitory computer-readable medium (e.g., a memory).

FIG. 11 illustrates an example computer system 1100 for executing the software components described herein for the sending/receiving and processing of tasks. With reference to FIG. 11, client device 110; provider reservation system 120; global reservation system 130; RMS 140, reservation environment 200; search engine 220; inventory management system 230; reservation management system 240; ticket management system 250; RMS 300, and any other computer system described herein, may be implemented on one or more computer devices or systems, such as exemplary computer system 1100. The computer system 1100 may include a processor 1126, a memory 1128, a mass storage memory device 1130, an input/output (I/O) interface 1132, and a Human Machine Interface (HMI) 1134. The computer system 1100 may also be operatively coupled to one or more external resources 1136 via the network 1123 or I/O interface 1132. External resources may include, but are not limited to, servers, databases, mass storage devices, peripheral devices, cloud-based network services, or any other suitable computer resource that may be used by the computer system 1100.

The processor 1126 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 1128. The memory 1128 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 1130 may include data storage devices such as a hard drive, optical drive, tape drive, non-volatile solid state device, or any other device capable of storing information.

The processor 1126 may operate under the control of an operating system 1138 that resides in the memory 1128. The operating system 1138 may manage computer resources so that computer program code embodied as one or more computer software applications, such as an application 1140 residing in memory 1128, may have instructions executed by the processor 1126. In an alternative embodiment, the processor 1126 may execute the application 1140 directly, in which case the operating system 1138 may be omitted. One or more data structures 1142 may also reside in memory 1128, and may be used by the processor 1126, operating system 1138, or application 1140 to store or manipulate data.

The I/O interface 1132 may provide a machine interface that operatively couples the processor 1126 to other devices and systems, such as the network 1123 or the one or more external resources 1136. The application 1140 may thereby work cooperatively with the network 1123 or the external resources 1136 by communicating via the I/O interface 1132 to provide the various features, functions, applications, processes, or modules including embodiments of the invention. The application 1140 may also have program code that is executed by the one or more external resources 1136, or otherwise rely on functions or signals provided by other system or network components external to the computer system 1100. Indeed, given the nearly endless hardware and software configurations possible, persons having ordinary skill in the art will understand that embodiments of the invention may include applications that are located externally to the computer system 1100, distributed among multiple computers or other external resources 1136, or provided by computing resources (hardware and software) that are provided as a service over the network 1123, such as a cloud computing service.

The HMI 1134 may be operatively coupled to the processor 1126 of computer system 1100 in a known manner to allow a user to interact directly with the computer system 1100. The HMI 1134 may include video or alphanumeric displays, a touch screen, a speaker, and any other suitable audio and visual indicators capable of providing data to the user. The HMI 1134 may also include input devices and controls such as an alphanumeric keyboard, a pointing device, keypads, pushbuttons, control knobs, microphones, etc., capable of accepting commands or input from the user and transmitting the entered input to the processor 1126.

A database 1144 may reside on the mass storage memory device 1130, and may be used to collect and organize data used by the various systems and modules described herein. The database 1144 may include data and supporting data structures that store and organize the data. In particular, the database 1144 may be arranged with any database organization or structure including, but not limited to, a relational database, a hierarchical database, a network database, or combinations thereof. A database management system in the form of a computer software application executing as instructions on the processor 1126 may be used to access the information or data stored in records of the database 1144 in response to a query, where a query may be dynamically determined and executed by the operating system 1138, other applications 1140, or one or more modules.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed:

1. A method comprising:
generating predicted booking observations with a demand model trained using a training set of historical booking data;
obtaining transient booking observations from an active database;
computing an observed likelihood score from the transient booking observations based on the demand model trained on the historical booking data;
computing a demand shock threshold based on a statistical relationship between a time to detection of a demand shock event and at least one shock detection criterion, wherein the demand shock threshold is computed based on a distribution of likelihood scores from simulated instances of the transient booking observations; and
determining an occurrence of a demand shock event by comparing the observed likelihood score to the demand shock threshold.

2. The method of claim 1, wherein the demand shock threshold is computed based on detecting a demand shock of a given magnitude at a given statistical accuracy within a desired detection time.

3. The method of claim 1, wherein the demand shock threshold is computed based on a distribution of likelihood scores from simulated instances of the transient booking observations that are generated based on an assumption that no demand shock has occurred.

4. The method of claim 1, further comprising:
determining a statistical relationship between an offered price and bookings associated with the historical booking data and the transient booking observations.

5. The method of claim 1, wherein the at least one shock detection criterion is based on a desired magnitude of the detected shock event.

6. The method of claim 1, wherein the at least one shock detection criterion is based on a desired statistical power.

7. The method of claim 1, wherein the at least one shock detection criterion is based on a sample size of the transient booking observations.

8. The method of claim 1, wherein generating the predicted booking observations comprises:
computing a probability that a travel service or a flight will receive a given number of bookings by a given day-to-departure (“DTD”) based on a demand forecast obtained using the demand model.

9. The method of claim 1, further comprising:
generating a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model.

10. A system comprising:
one or more processors;
at least one memory device coupled with the one or more processors; and
a data communications interface operably associated with the one or more processors, wherein the at least one memory device contains a plurality of program instructions that, when executed by the one or more processors, cause the system to:
generate predicted booking observations with a demand model trained using a training set of historical booking data;
obtain transient booking observations from an active database;
compute an observed likelihood score from the transient booking observations based on the demand model trained on the historical booking data;
compute a demand shock threshold based on a statistical relationship between a time to detection of a demand shock event and at least one shock detection criterion, wherein the demand shock threshold is computed based on a distribution of likelihood scores from simulated instances of the transient booking observations; and
determine an occurrence of a demand shock event by comparing the observed likelihood score to the demand shock threshold.

11. The system of claim 10, wherein the demand shock threshold is computed based on detecting a demand shock of a given magnitude at a given statistical accuracy within a desired detection time.

12. The system of claim 10, wherein the demand shock threshold is computed based on a distribution of likelihood scores from simulated instances of the transient booking observations that is generated based on an assumption that no demand shock has occurred.

13. The system of claim 10, wherein the plurality of program instructions, when executed by the one or more processors, further cause the system to determine a statistical relationship between an offered price and bookings associated with the historical booking data and the transient booking observations.

14. The system of claim 10, wherein the at least one shock detection criterion is based on a desired magnitude of the detected shock event.

15. The system of claim 10, wherein the at least one shock detection criterion is based on a desired statistical power.

16. The system of claim 10, wherein the at least one shock detection criterion is based on a sample size of the transient booking observations.

17. The system of claim 10, wherein the plurality of program instructions, when executed by the one or more processors, further cause the system to:
generate a confidence cone by aggregating a set of probabilities computed for multiple flights with each probability estimating a likelihood that a given flight among the multiple flights will receive a given number of bookings by a given day-to-departure (“DTD”) based on a demand forecast obtained using the demand model.

18. A computer program product comprising:
a non-transitory computer-readable storage medium; and
program code stored on the non-transitory computer-readable storage medium that, when executed by one or more processors, causes the one or more processors to:
generate predicted booking observations with a demand model trained using a training set of historical booking data;
obtain transient booking observations from an active database;
compute an observed likelihood score from the transient booking observations based on the demand model trained on the historical booking data;
compute a demand shock threshold based on a statistical relationship between a time to detection of a demand shock event and at least one shock detection criterion, wherein the demand shock threshold is computed based on a distribution of likelihood scores from simulated instances of the transient booking observations; and
determine an occurrence of a demand shock event by comparing the observed likelihood score to the demand shock threshold.

19. A computer program product of claim 18, wherein the demand shock threshold is computed based on detecting a demand shock of a given magnitude at a given statistical accuracy within a desired detection time.

20. A computer program product of claim 18, wherein the demand shock threshold is computed based on a distribution of likelihood scores from simulated instances of the transient booking observations that is generated based on an assumption that no shock behavior has occurred.
